(19) United States
(12) Patent Application Publication
(10) Pub. No.: US 2026/0165905 A1
(43) Pub. Date: Jun. 18, 2026

(54) Therapeutic Device with Inflatable Chambers Configured for Sequential or Simultaneous Pressurization and Depressurization

(71) Applicant: IPLEXXUS HOLDINGS, LLC, Freeland, MI (US)

(72) Inventor: David A. DZIOBA, Freeland, MI (US)

(21) Appl. No.: 19/422,150

(22) Filed: Dec. 16, 2025

Related U.S. Application Data
(60) Provisional application No. 63/735,079, filed on Dec. 17, 2024.

(51) Int. Cl. A61H 9/00; A61G 7/057

(52) U.S. Cl. CPC A61H 9/0078; A61H 9/0007; A61G 7/05776

(57) ABSTRACT

A therapeutic device includes a selectively inflatable compartment including a manifold configured to selectively receive and vent pressurized fluid, for example, from and to a controller. Plural inflatable chambers are fluidly connected to the manifold via respective intervening flow control systems. The flow control systems are configured to enable simultaneous or sequential pressurization and depressurization of the inflatable chambers in response to the introduction of pressurized fluid to the manifold and venting of fluid from the manifold.

### CROSS-REFERENCE TO RELATED APPLICATIONS

This application claims benefit under 35 U.S.C. § 119 of U.S. Provisional Patent Application No. 63/735,079, filed on Dec. 17, 2024, and incorporates by reference the disclosure thereof in its entirety. This disclosure incorporates by reference in their entireties the disclosures of: U.S. Provisional Patent Application No. 63/566,579, filed on Mar. 18, 2024; U.S. Provisional Patent Application No. 63/652,453, filed on May 28, 2024; and U.S. Provisional Patent Application No. 63/811,011, filed on May 23, 2025. To the extent a conflict may exist between the foregoing disclosures and the present disclosure, the present disclosure shall prevail.

### BACKGROUND OF THE DISCLOSURE

Selectively inflatable therapeutic devices, for example, support surface overlays directed to mitigation of decubitus ulcers and sequential compression devices directed to promotion of directional blood flow, are known in the art. Some such therapeutic devices include plural independently and selectively inflatable compartments. Inflation and deflation of the plural inflatable compartments typically is effected by a controller coupled to the therapeutic device. Such controllers typically include a pneumatic pump and an arrangement of valves configured to independently and selectively direct pressurized air to one or more or all of the plural inflatable compartments, and to independently and selectively vent air from one or more or all of the plural inflatable compartments.

For example, a typical support surface overlay includes at least first and second selectively and alternatingly inflatable compartments defining respective contact areas configured to selectively and alternatingly apply and relieve contact pressure to corresponding portions of a user's body. A typical support surface overlay having first and second selectively and alternatingly inflatable compartments typically is used in conjunction with a controller having a first fluid line fluidly coupled to the first inflatable compartment and a second fluid line fluidly coupled to the second inflatable compartment. A typical controller for a support surface overlay is configured to selectively provide pressurized air to the first inflatable compartment while venting the second inflatable compartment, and to subsequently provide pressurized air to the second inflatable compartment while venting the first inflatable compartment. Each of the first and second inflatable compartments may apply contact pressure to the skin of a user lying thereon when the respective inflatable compartment is inflated, and each of the first and second inflatable compartments may relieve contact pressure from the skin of a user lying thereon when the respective inflatable compartment is deflated. In embodiments, either or both of the first and second inflatable compartments may include plural inflatable chambers. Typically, the plurality of inflatable chambers within a given inflatable compartment are connected together by a common manifold. As such, the plurality of inflatable chambers within a given inflatable compartment typically inflate and deflate in unison with each other, along with inflation and deflation of the inflatable compartment as a whole. Such inflatable chambers typically are arranged in rows and/or columns within the respective inflatable compartment.

A sequential compression device (SCD) is a wearable therapeutic device that includes at least a first selectively inflatable compartment and may include at least first and second inflatable compartments. The selectively inflatable compartment(s) may be inflated and deflated in a manner that promotes directional blood flow, for example, from a user's extremity toward the user's heart. For example, an SCD may take the form of a sock or a cuff that a user may wear on his or her foot or lower leg. Such an SCD may include a first inflatable compartment distant from the user's heart and a second inflatable compartment proximate the user's heart. A typical SCD having at least two selectively and alternatingly inflatable compartments typically is used in conjunction with a controller having a first fluid line fluidly coupled to the first inflatable compartment, a second fluid line fluidly coupled to the second inflatable compartment, and further fluid lines fluidly coupled to respective further inflatable compartments. A typical controller for an SCD is configured to inflate the first inflatable compartment, and then to inflate the second inflatable compartment while maintaining the first inflatable compartment in the inflated state. The controller may subsequently vent and thereby deflate the second inflatable compartment and then vent and thereby deflate the first inflatable compartment while maintaining the second inflatable compartment in the deflated state. Alternatively, the controller may subsequently vent and thereby deflate the first inflatable compartment and then vent and thereby deflate the second inflatable compartment while maintaining the first inflatable compartment in the deflated state.

It would be beneficial to provide a selectively inflatable therapeutic device having at least one selectively inflatable compartment including plural inflatable chambers configured to enable simultaneous or sequential inflation and simultaneous or sequential deflation of the plural inflatable chambers thereof via a single fluid line configured to provide fluid to and relieve fluid from the selectively inflatable compartment.

### SUMMARY OF THE DISCLOSURE

The present disclosure is directed to a therapeutic device having a first selectively inflatable compartment including: a first manifold configured for fluid connection to a controller configured to supply pressurized fluid to, and to relieve the pressurized from, the first manifold; a first inflatable chamber fluidly coupled to the first manifold, the first inflatable chamber inflatable to a first inflation pressure; a second inflatable chamber fluidly coupled to the first manifold, the second inflatable chamber inflatable to the first inflation pressure; a first flow control system fluidly coupled between the first manifold and the first inflatable chamber; and a second flow control system fluidly coupled between the first manifold and the second inflatable chamber. The first flow control system may be configured to regulate flow of fluid into the first inflatable chamber and to regulate flow of fluid out of the first inflatable chamber, and the first flow control system may include a first primary flow regulator. The second flow control system may be configured to regulate flow of fluid into the second inflatable chamber and to regulate flow of fluid out of the second inflatable chamber, and the second flow control system may include a second primary flow regulator. The first flow control system and the second flow control system may be configured to enable pressurization of the first inflatable chamber from a first reference pressure to a first inflation pressure and pressurization of the second inflatable chamber from the first reference pressure to the first inflation pressure substantially simultaneously or in a first predetermined sequence. The first flow control system and the second flow control system also may be configured to enable depressurization of the first inflatable chamber and the second inflatable chamber from the first inflation pressure to a second reference pressure substantially simultaneously or in a second predetermined sequence.

The first flow control system and the second flow control system may be configured to enable pressurization of the first inflatable chamber and the second inflatable chamber from the first reference pressure to the first inflation pressure in the first predetermined sequence. The first flow control system and the second flow control system may be configured to enable depressurization of the first inflatable chamber and the second inflatable chamber from the first inflation pressure to the second reference pressure in the second predetermined sequence. The first predetermined sequence may the same as or different than the second predetermined sequence. The first flow control system and the second flow control system may configured to enable depressurization of the first inflatable chamber and the second inflatable chamber from the first inflation pressure to the second reference pressure substantially simultaneously.

The first flow control system and the second flow control system may be configured to enable pressurization of the first inflatable chamber and the second inflatable chamber from the first reference pressure to the first inflation pressure substantially simultaneously, and they may be configured to enable depressurization of the first inflatable chamber and the second inflatable chamber from the first inflation pressure to the second reference pressure substantially simultaneously.

The first primary flow regulator may be a flow-restricting orifice. The first flow control system may also include a first secondary flow regulator fluidly connected in parallel with the first primary flow regulator. The first secondary flow regulator may be a first check valve. The first primary flow regulator may be a flow-restricting orifice integrated with the first check valve. The first check valve may be configured to enable flow into the first inflatable chamber and to check flow out of the first inflatable chamber. The second flow control system may also include a second secondary flow regulator fluidly connected in parallel with the second flow-restricting orifice.

The therapeutic surface may also include a third inflatable chamber fluidly coupled to the first manifold and a third flow control system fluidly coupled between the first manifold and the third inflatable chamber. The third inflatable chamber may be inflatable to the first inflation pressure. The third flow control system may include a third primary flow regulator. The third flow control system may be configured to regulate flow of fluid into the third inflatable chamber and to regulate flow of fluid out of the third inflatable chamber. The third flow control system may also include a third secondary flow regulator fluidly connected in parallel with the third primary flow regulator.

The first flow control system, the second flow control system, and the third flow control system may be configured to enable pressurization of the third inflatable chamber from the first reference pressure to the first inflation pressure following pressurization of the first inflatable chamber and the second inflatable chamber from the first reference pressure to the first inflation pressure. The first flow control system, the second flow control system, and the third flow control system may be configured to enable depressurization of the third inflatable chamber from the first inflation pressure to the second reference pressure prior to depressurization of the first inflatable chamber and the second inflatable chamber from the first inflation pressure to the second reference pressure. The first flow control system, the second flow control system, and the third flow control system may be configured to enable depressurization of the third inflatable chamber from the first inflation pressure to the second reference pressure following depressurization of the first inflatable chamber and the second inflatable chamber from the first inflation pressure to the second reference pressure.

The therapeutic device may be a sequential compression device or a support surface overlay.

### BRIEF DESCRIPTION OF THE DRAWINGS

FIG. 1 depicts an illustrative therapeutic device in the form of a sequential compression device (SCD) having a selectively inflatable compartment including plural inflatable chambers and corresponding flow control systems configured to enable inflation of the plural inflatable chambers simultaneously or sequentially and to enable deflation of the plural inflatable chambers simultaneously or sequentially according to the present disclosure;

FIG. 2 depicts an illustrative therapeutic device in the form of a support surface overlay (SSO) having a selectively inflatable compartment including plural inflatable chambers and corresponding flow control systems configured to enable inflation of the plural inflatable chambers in a simultaneously or sequentially and to enable deflation of the plural inflatable chambers simultaneously or sequentially according to the present disclosure;

FIG. 3 depicts schematically the therapeutic device of either FIG. 1 or FIG. 2, including the plural inflatable chambers thereof, and corresponding flow control systems configured to enable inflation of the plural inflatable chambers simultaneously or sequentially and to enable deflation of the plural inflatable chambers simultaneously or sequentially;

FIG. 4 is a graph depicting an illustrative cycle of inflation and deflation of the plural inflatable chambers of the therapeutic device of either FIG. 1 or FIG. 2, wherein the plural inflatable chambers are inflated in a first sequence and are deflated simultaneously;

FIG. 5 is a graph depicting an illustrative cycle of inflation and deflation of the plural inflatable chambers of the therapeutic device of either FIG. 1 or FIG. 2, wherein the plural inflatable chambers are inflated in a first sequence and are deflated in a second sequence, wherein the second sequence is the same as the first sequence;

FIG. 6 is a graph depicting an illustrative cycle of inflation and deflation of the plural inflatable chambers of the therapeutic surface of either FIG. 1 or FIG. 2, wherein the plural inflatable chambers are inflated in a first sequence and are deflated in a second sequence, wherein the second sequence is different from the first sequence;

FIG. 7 is a graph depicting an illustrative cycle of inflation and deflation of the plural inflatable chambers of the SCD, wherein the plural inflatable chambers are inflated simultaneously and are deflated in a first sequence;

FIG. 8 depicts an illustrative support surface further including a second selectively inflatable compartment including second plural inflatable chambers and corresponding control systems configured to enable inflation of the second plural inflatable chambers in a first sequence or simultaneously and to enable deflation of the plural inflatable chambers in a second sequence or simultaneously according to the present disclosure;

FIG. 9 depicts an illustrative support surface having a first selectively inflatable compartment having plural inflatable chambers, wherein the plural inflatable chambers are arranged concentrically;

FIG. 10 depicts schematically another therapeutic device similar to the therapeutic device of either FIG. 1 or FIG. 2, including the plural inflatable chambers thereof, and flow restrictors configured to enable sequential inflation and deflation of the plural inflatable chambers; and

FIGS. 11A-13B depict material layers of the therapeutic device of FIGS. 1 and 2 in various stages of assembly.

### DETAILED DESCRIPTION OF THE DRAWINGS

The drawings depict various embodiments of therapeutic devices, each such therapeutic device having at least one selectively inflatable compartment, and each such selectively inflatable compartment including plural inflatable chambers. The therapeutic devices are configured so that the plural inflatable chambers may be inflated simultaneously or sequentially in a predetermined inflation sequence, and so that the plural inflatable chambers may be deflated simultaneously or sequentially in a predetermined deflation sequence. In embodiments wherein the plural inflatable chambers may be inflated sequentially and deflated sequentially, the inflation sequence may be the same as or different from the deflation sequence.

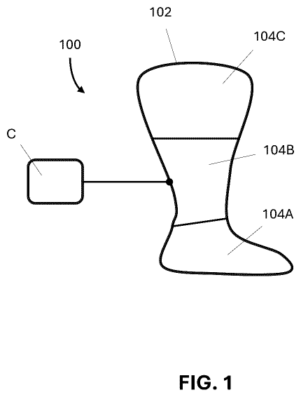

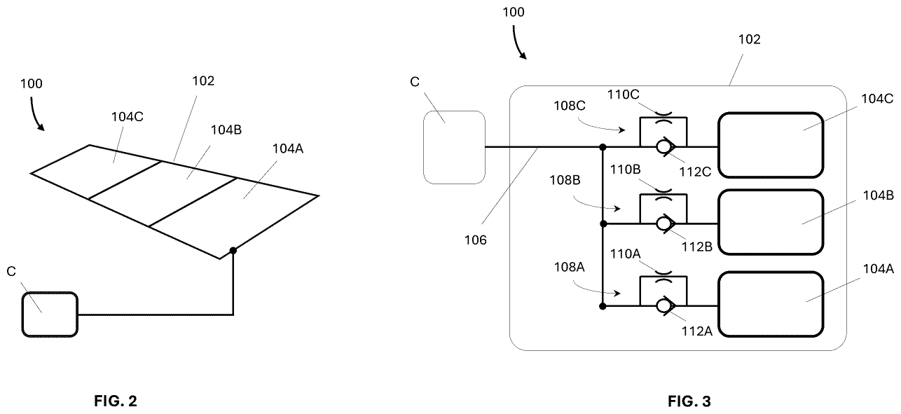

FIGS. 1-3 depict embodiments of an illustrative therapeutic device 100 having a first selectively inflatable compartment 102 fluidly coupled to a controller C. The controller C is configured to selectively provide pressurized fluid to, and relieve pressurized fluid from, the first selectively inflatable compartment 102. The pressurized fluid may be a gas, for example, air. In embodiments, the pressurized fluid may be a liquid, for example, water. As shown in FIG. 1, the therapeutic device 100 may be embodied as a sequential compression device (SCD). As shown in FIG. 2, the therapeutic device 100 may be embodied as a support surface overlay (SSO). The therapeutic device 100 may be embodied in other forms, as well. In embodiments, the therapeutic device 100 may include plural selectively inflatable compartments, as will be discussed further below.

The first selectively inflatable compartment 102 includes a plurality of fluidly interconnected inflatable chambers 104n. As shown in FIGS. 1 and 2, the first selectively inflatable compartment 102 includes a first inflatable chamber 104A, a second inflatable chamber 104B, and a third inflatable chamber 104C. In embodiments, the first selectively inflatable compartment 102 may include fewer or more than three inflatable chambers 104n. In embodiments, the first selectively inflatable compartment 102 includes at least two inflatable chambers. In embodiments, the first selectively inflatable compartment 102 includes a single inflatable chamber, as discussed further below. In embodiments including plural selectively inflatable compartments, each selectively inflatable compartment may include two or more inflatable chambers, as will be discussed further below.

As shown in FIG. 3, ones of the plurality of inflatable chambers 104n may be fluidly connected together by a manifold 106. The manifold 106 may be fluidly coupled to the controller C so that the controller C may selectively provide pressurized fluid to, and vent the pressurized fluid from, the manifold 106 and thereby selectively provide pressurized fluid to and vent the pressurized fluid from the first, second and third inflatable chambers 104A, 104B, 104C.

A respective flow control system 108n may be fluidly connected between the manifold 106 and a corresponding one of the inflatable chambers 104n. For example, as shown, a first flow control system 108A is fluidly coupled between the first inflatable chamber 104A and the manifold 106. Similarly, a second flow control system 108B is fluidly coupled between the second inflatable chamber 102B and the manifold 106, and a third flow control system 108C is fluidly coupled between the second inflatable chamber 102C and the manifold 106.

As will be discussed further below, each of the flow control systems 108n is configured to impart a corresponding restriction to flow therethrough in a first direction at a first reference differential pressure, and to also impart a corresponding restriction to flow therethrough in a second direction at a second reference differential pressure. The restriction to flow in the second direction through any particular one of the flow control systems 108n may be less than, the same as, or greater than the restriction to flow in the first direction through the same particular one of the flow control systems 108n. The restriction to flow in the first direction through a particular one of the flow control systems 108n may be the same as the restriction to flow in the first direction through another particular one or ones of the flow control systems 108n. Alternatively, the restriction to flow in the first direction through a particular one of the flow control systems 108n may be different than the restriction to flow in the first direction through all of the other ones of the flow control systems 108n. Similarly, the restriction to flow in the second direction through a particular one of the flow control systems 108n may be the same as the restriction to flow in the second direction through another particular one or ones of the flow control systems 108n. Alternatively, the restriction to flow in the second direction through a particular one of the flow control systems 108n may be different than the restriction to flow in the second direction through all of the other ones of the flow control systems 108n. The second reference differential pressure has the opposite direction as the first reference differential pressure. The second reference differential pressure and the first reference differential pressure may have the same magnitude or different magnitudes.

Consequently, the flow control systems 108n collectively are configured to enable pressurization and depressurization of ones of the inflatable chambers 104n with respect to other ones of the inflatable chambers 104n from a first reference pressure PR1 to a first inflation pressure PI1 substantially simultaneously or sequentially in response to the controller C providing pressurized fluid to or venting pressurized fluid from the first inflatable compartment 102. More specifically, the flow control systems 108n may be configured so that the corresponding inflatable chambers 104n inflate substantially simultaneously or in a first predetermined, desired sequence from the first reference pressure PR1 to the first inflation pressure PI1 in response to the controller C providing pressurized fluid to the first inflatable compartment 102. Similarly, the flow control systems 108n may be configured so that the corresponding inflatable chambers 104n deflate substantially simultaneously or in a second predetermined, desired sequence from the first inflation pressure PI1 to a second reference pressure PR2 in response to the controller C venting pressurized fluid from the first inflatable compartment 102. The first sequence and the second sequence may be the same or different. The second reference pressure PR2 may be the same as or different than the first reference pressure PR1. Certain specific, non-limiting examples of such simultaneous and/or sequential inflation and deflation of the inflatable chambers 104n will be discussed further below.

As shown in FIG. 3, the first flow control system 108A includes a first primary flow regulator 110A and a first secondary flow regulator 112A in parallel fluid communication with the first primary flow regulator 110A. As suggested above, the first primary flow regulator 110A and the first secondary flow regulator 112A cooperate to impart a first restriction to flow through the first flow control system 108A in a first direction at the first reference differential pressure across the first flow control system 108A, and to thereby enable a fluid to flow through the first flow control system 108A in a first direction (for example, into the first inflatable chamber 104A) at a first flow rate at the first reference differential pressure across the first flow control system 108A. Likewise, the first primary flow regulator 110A and the first secondary flow regulator 112A cooperate to impart a second restriction to flow through the first flow control system 108A in a second direction at the second reference differential pressure across the first flow control system 108A, and to thereby enable a fluid to flow through the first flow control system 108A in a second direction (for example, out of the first inflatable chamber 104A) at a second flow rate at the second reference differential pressure across the first flow control system 108A. As mentioned above, the second reference differential pressure has the opposite direction as the first reference differential pressure. As also mentioned above, the second reference differential pressure and the first reference differential pressure may have the same magnitude or different magnitudes. The first restriction to flow may the same as or different than the second restriction to flow. Accordingly, the first flow rate may the same as or different than the second flow rate. In embodiments, the first secondary flow regulator 112A may be omitted and thereby not contribute to the first and second restrictions to flow and the first and second flow rates.

As also shown in FIG. 3, the second flow control system 108B includes a second primary flow regulator 110B and a second secondary flow regulator 112B in parallel fluid communication with the second primary flow regulator 110B. As suggested above, the second primary flow regulator 110B and the second secondary flow regulator 112B cooperate to impart a third restriction to flow through the second flow control system 108B in a first direction at the first reference differential pressure across the second flow control system 108B, and to thereby enable a fluid to flow through the second flow control system 108B in a first direction (for example, into the first inflatable chamber 104B) at a third flow rate at the first reference differential pressure across the second flow control system 108B. Likewise, the second primary flow regulator 110B and the second secondary flow regulator 112B cooperate to impart a fourth restriction to flow through the second flow control system 108B in a second direction at the second reference differential pressure across the second flow control system 108B, and to thereby enable a fluid to flow through the second flow control system 108B in a second direction (for example, out of the second inflatable chamber 104B) at a fourth flow rate at the second reference differential pressure across the second flow control system 108B. As mentioned above, the second reference differential pressure has the opposite direction as the first reference differential pressure. As also mentioned above, the second reference differential pressure and the first reference differential pressure may have the same magnitude or different magnitudes. The third restriction to flow may the same as or different than the fourth restriction to flow. Accordingly, the third flow rate may the same as or different than the fourth flow rate. Also, either or both of the third restriction to flow and the fourth restriction to flow may be the same as or different than either or both of the first restriction to flow and the second restriction to flow. Accordingly, either or both of the third flow rate and the fourth flow rate may be the same as or different than either or both of the first flow rate and the second flow rate. In embodiments, the second secondary flow regulator 112B may be omitted and thereby not contribute to the third and fourth restrictions to flow and the third and fourth flow rates.

As further shown in FIG. 3, the third flow control system 108C includes a third primary flow regulator 110C and a third secondary flow regulator 112C in parallel fluid communication with the third primary flow regulator 110C. As suggested above, the third primary flow regulator 110C and the third secondary flow regulator 112C cooperate to impart a fifth restriction to flow through the third flow control system 108C in a first direction at the first reference differential pressure across the third flow control system 108C, and to thereby enable a fluid to flow through the third flow control system 108C in a first direction (for example, into the third inflatable chamber 104C) at a fifth flow rate at the first reference differential pressure across the third flow control system 108C. Likewise, the third primary flow regulator 110C and the third secondary flow regulator 112C cooperate to impart a sixth restriction to flow through the third flow control system 108C in a second direction at the second reference differential pressure across the third flow control system 108C, and to thereby enable a fluid to flow through the third flow control system 108C in a second direction (for example, out of the third inflatable chamber 104C) at a sixth flow rate at the second reference differential pressure across the third flow control system 108C. As mentioned above, the second reference differential pressure has the opposite direction as the first reference differential pressure. As also mentioned above, the second reference differential pressure and the first reference differential pressure may have the same magnitude or different magnitudes. The fifth restriction to flow may the same as or different than the sixth restriction to flow. Accordingly, the fifth flow rate may the same as or different than the sixth flow rate. Also, either or both of the fifth restriction to flow and the sixth restriction to flow may be the same as or different than any or all of the first restriction to flow, the second restriction to flow, the third restriction to flow, and the fourth restriction to flow. Accordingly, either or both of the fifth flow rate and the sixth flow rate may be the same as or different from any or all of the first flow rate, the second flow rate, the third flow rate, and the fourth flow rate. In embodiments, the third secondary flow regulator 112C may be omitted and thereby not contribute to the fifth and sixth restrictions to flow and the fifth and sixth flow rates.

The primary flow regulators 110n may be embodied as any structure configured to: (i) impart a desired predetermined restriction to flow therethrough in the first direction at the first reference differential pressure and thereby enable a desired, predetermined fluid flow rate therethrough in the first direction at the first reference differential pressure; and (ii) impart a desired predetermined restriction to flow therethrough in the second direction at the second reference differential pressure and thereby enable a desired, predetermined fluid flow rate therethrough, or disable flow therethrough, in the second direction at the second reference differential pressure. The secondary flow regulators 112n may be embodied as any structure configured to: (i) impart a desired predetermined restriction to flow therethrough, or disable flow therethrough, in the first direction at the first reference differential pressure and thereby enable a desired, predetermined fluid flow rate therethrough in the first direction at the first reference differential pressure; and (ii) impart a desired predetermined restriction to flow therethrough in the second direction at the second reference differential pressure and thereby enable a desired, predetermined fluid flow rate therethrough in the second direction at the second reference differential pressure.

For example, as shown in FIG. 3, each of the primary flow regulators 110n may be embodied as a flow-restricting orifice sized to: (i) impart a corresponding, desired, predetermined restriction to fluid flow therethrough in the first direction at the first reference differential pressure, and thereby enable a corresponding, desired, predetermined fluid flow rate therethrough at the first reference differential pressure; and (ii) impart a corresponding, desired, predetermined restriction to fluid flow therethrough in the second direction at the second reference differential pressure, and thereby enable a corresponding, desired, predetermined fluid flow rate therethrough in the second direction at the second reference differential pressure. In embodiments, any or all of the primary flow regulators 110n may be alternatively embodied as, for example without limitation, a check valve configured to enable flow therethrough in the first direction at the first reference differential pressure, and to check (disable) flow therethrough in the second direction at the second reference differential pressure.

As also shown in FIG. 3, each of the secondary flow regulators 112n may be embodied as a check valve configured to enable flow therethrough in the second direction at the second reference differential pressure, and to check (disable) flow therethrough in the first direction at the first reference differential pressure (or to enable fluid flow therethrough at a lesser flow rate in the first direction at the first reference differential pressure than in the second direction at the second reference differential pressure). Such a check valve may be configured to further impart a desired, predetermined restriction to fluid flow therethrough in the second direction at the second reference differential pressure, and thereby enable a desired, predetermined fluid flow rate therethrough at the second reference differential pressure. In embodiments, any or all of the secondary flow regulators 112n may be embodied as any other structure or piping element or combination of elements configured to enable flow therethrough in the second direction at the second reference differential pressure, and to check (disable) flow therethrough in the first direction at the first reference differential pressure (or to enable fluid flow therethrough at a lesser flow rate in the first direction at the first reference differential pressure than in the second direction at the second reference differential pressure).

In embodiments (not shown), any or all of the primary flow regulators 110n may be integrated with the corresponding secondary flow regulator 112n. For example, an integrated primary flow regulator 110n and corresponding secondary flow regulator 112n could be embodied as a check valve including an orifice in a flow-controlling plug or disc thereof, wherein the integrated primary flow regulator 110n and corresponding secondary flow regulator 112n would be configured to: (i) impart a desired, predetermined restriction to fluid flow therethrough in the first direction at the first reference differential pressure, and thereby enable a desired, predetermined fluid flow rate therethrough at the first reference differential pressure; and (ii) impart a different desired, predetermined restriction to fluid flow therethrough in the second direction at the second reference differential pressure, and thereby enable a desired, predetermined fluid flow rate therethrough in the second direction at the second reference differential pressure.

In any event, the primary flow regulators 110n and the secondary flow regulators 112n cooperate to enable the first though sixth restrictions to fluid flow and the first through sixth fluid flow rates though the several flow control systems 108n, as discussed above.

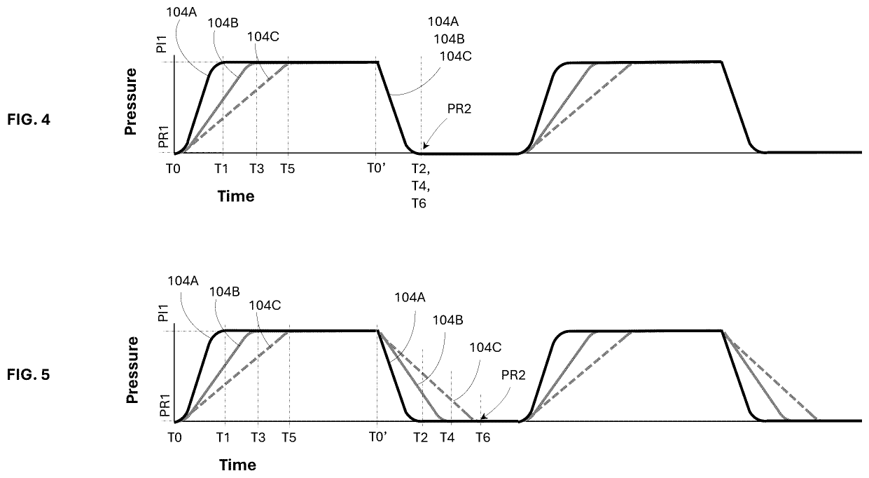

With reference to FIGS. 4-7, the several flow control systems 108n are configured to enable pressurization of the several inflatable chambers 104n to begin substantially simultaneously and to end substantially simultaneously or in a predetermined sequence. Similarly, the several flow control systems 108n also are configured to enable de-pressurization of the several inflatable chambers 104n to begin substantially simultaneously and to end substantially simultaneously or in a predetermined sequence.

More specifically, the first flow control system 108A is configured to enable pressurization of the first inflatable chamber 104A from a first reference pressure PR1, for example, ambient pressure, beginning at time T0 to a first inflation pressure PI1 at a first time T1 in response to the provision of pressurized fluid from a source of pressurized fluid to the manifold 106 and thereby to the first flow control system 108A and to the first inflatable chamber 104A. The first flow control system 108A also is configured to enable depressurization of the first inflatable chamber 104A from the first inflation pressure PI1 beginning at time T0′ to a second reference pressure PR2 at a second time T2 in response to venting of the pressurized fluid from the manifold 106 and thereby from the first inflatable chamber 104A via the first flow control system 108A. The second reference pressure PR2 may be higher than, lower than, or the same as the first reference pressure PR1. The second time T2 is later than the first time T1.

Similarly, the second flow control system 108B is configured to enable pressurization of the second inflatable chamber 104B from the reference pressure beginning at time T0 to the first inflation pressure at a third time T3 in response to the provision of pressurized fluid from the source of pressurized fluid to the manifold 106 and thereby to the second flow control system 108B and to the second inflatable chamber 104B. The second flow control system 108B also is configured to enable depressurization of the second inflatable chamber 104B from the first inflation pressure PI1 beginning at time T0′ to the second reference pressure PR2 at a fourth time T4 in response to venting of the pressurized fluid from the manifold 106 and thereby from the second inflatable chamber 104B via the second flow control system 108B. The third time T3 may be the same as, earlier than, or later than the first time T1. The fourth time T4 is later than the third time, and it may be the same as, earlier than, or later than the second time T2.

Likewise, the third flow control system 108C is configured to enable pressurization of the third inflatable chamber 104C from the first reference pressure PR1 beginning at time T0 to the first inflation pressure PI1 at a fifth time T5 in response to the provision of pressurized fluid from the source of pressurized fluid to the manifold 106 and thereby to the third flow control system 108C and to the third inflatable chamber 104C. The third flow control system 108C also is configured to enable depressurization of the third inflatable chamber 104C from the first inflation pressure PI1 beginning at time T0′ to the second reference pressure PR2 at a sixth time T6 in response to venting of the pressurized fluid from the manifold 106 and thereby from the third inflatable chamber 104C via the third flow control system 108C. The fifth time T5 may be the same as, earlier than, or later than the first time T1, and it may be the same as, earlier than, or later than the third time T3. The sixth time T6 is later than the fifth time, and it may be the same as, earlier than, or later than the second time T2, and it may be the same as, earlier than, or later than the fourth time T4.

Each of the first, third, and fifth times T1, T3, T5 may be a function of at least the respective restrictions to flow of the first, second, and third primary flow regulators 110A, 110B, 110C, the respective restrictions to flow of the first, second, and third secondary flow regulators 112A, 112B, 112C (including without limitation, as may be applicable, enabling flow into the respective inflatable chamber 104A, 104B, 104C and checking flow out of the respective inflatable chamber 104A, 104B, 104C vs. checking flow into the respective inflatable chamber 104A, 104B, 104C and enabling flow out of the respective inflatable chamber 104A, 104B, 104C), the respective volumes of the first, second, and third inflatable chambers 104A, 10B, 104C, the first reference pressure PR1, the first inflation pressure PI1, and the pressure of the pressurized fluid provided to the manifold 106 and thereby to the respective flow control system 108A, 108B, 108C and the respective inflatable chamber 104A, 104B, 104C.

Each of the second, fourth, and sixth times T2, T4, T6 may be a function of at least the respective restrictions to flow of the first, second, and third primary flow regulators 110A, 110B, 110C, the respective restrictions to flow of the first, second, and third secondary flow regulators 112A, 112B, 112C (including without limitation, as may be applicable, enabling flow into the respective inflatable chamber 104A, 104B, 104C and checking flow out of the respective inflatable chamber 104A, 104B, 104C vs. checking flow into the respective inflatable chamber 104A, 104B, 104C and enabling flow out of the respective inflatable chamber 104A, 104B, 104C), the respective volumes of the first, second, and third inflatable chambers 104A, 104B, 104C, the first inflation pressure PI1, the second reference pressure PR2, and the rate at which the pressurized fluid is vented from the manifold 106 and thereby from the respective flow control system 108A, 108B, 108C and the respective inflatable chamber 104A, 104B, 104C.

As such, the first, second, and third flow control systems 108A, 108B, 108C of the therapeutic device 100 may be configured so that the first, second, and third inflatable chambers 104A, 104B, 104C become pressurized from the first reference pressure PR1 to the first inflation pressure PI1 simultaneously or in any desired, first, predetermined sequence in response to provision of the pressurized fluid to the manifold 106 and thereby to each of the first, second, and third inflatable chambers 104A, 104B, 104C via the respective ones of the first, second, and third flow control systems 108A, 108B, 108C. Similarly, the first, second, and third flow control systems 108A, 108B, 108C of the therapeutic device 100 may be configured so that the first, second, and third inflatable chambers 104A, 104B, 104C become de-pressurized from the first inflation pressure PI1 to the second reference pressure PR2 simultaneously or in any desired, second, predetermined sequence in response to venting of the pressurized fluid from the manifold 106 and thereby from each of the first, second, and third inflatable chambers 104A, 104B, 104C via the respective ones of the first, second, and third flow control systems 108A, 108B, 108C. The second predetermined sequence may be the same as different than the first predetermined sequence.

For example, as shown in FIGS. 4 and 5, the first, second, and third flow control systems 108A, 108B, 108C of therapeutic device 100 may be configured so that, in response to provision of the pressurized fluid to the manifold 106 and thereby to the each of the first, second, and third flow control systems 108A, 108B, 108C and to each of the first, second third inflatable chambers 104A, 104B, 104C: (i) the first inflatable chamber 104A is pressurized from the first reference pressure PR1 to the first inflation pressure PI1 beginning at time T0 with pressurization completed at time T1; (ii) the second inflatable chamber 104B is pressurized from the first reference pressure PR1 to the first inflation pressure PI1 beginning at time T0 with pressurization completed at time T3 (after the first inflatable chamber 104A has been pressurized to the first inflation pressure PI1); and (iii) the third inflatable chamber 104C is pressurized from the first reference pressure PR1 to the first inflation pressure PI1 beginning at time T0 with pressurization completed at time T5 (after the second inflatable chamber 104B has been pressurized to the first inflation pressure PI1. In this manner, the therapeutic device 100 may function to direct a user's blood flow in a direction corresponding to the sequence of inflation of the first, second, and third inflatable chambers 104A, 104B, 104C.

Further, as shown in FIG. 4, the first, second, and third flow control systems 108A, 108B, 108C of the therapeutic device 100 may be configured so that, in response to venting of the pressurized fluid from the manifold 106 and thereby from each of the first, second, and third inflatable chambers 104A, 104B, 104C via the respective ones of the first, second, and third flow control systems 108A, 108B, 108C, the first, second, and third inflatable chambers 104A, 104B, 104C depressurize from the first inflation pressure PI1 beginning at time T0′ to the second reference pressure PR2 at times T2, T4, T6 substantially simultaneously.

Alternatively, as shown in FIG. 5, the first, second, and third flow control systems 108A, 108B, 108C of the therapeutic device 100 may be configured so that, in response to venting of the pressurized fluid from the manifold 106 and thereby from each of the first, second, and third inflatable chambers 104A, 104B, 104C via the respective ones of the first, second, and third flow control systems 108A, 108B, 108C: (i) the first inflatable chamber 104A is depressurized from the first inflation pressure PI1 to the second reference pressure PR2 beginning at time T0′ with depressurization completed at time T2; (ii) the second inflatable chamber 104B is depressurized from the first inflation pressure PI1 to the second reference pressure PR2 beginning at time T0′ with depressurization completed at time T4 (after the first inflatable chamber 104A has been depressurized to the second reference pressure PR2); and (iii) the third inflatable chamber 104C is depressurized from the first inflation pressure PI1 to the second reference pressure PR2 beginning at time T0′ with depressurization completed at time T6 (after the second inflatable chamber 104B has been depressurized to the second reference pressure PR2).

In embodiments, the first, second, and third flow control systems 108A, 108B, 108C of the therapeutic device 100 may be configured so that so that the first, second, and third inflatable chambers 104A, 104B, 104C may be pressurized from the first reference pressure PR1 to the first inflation pressure PI1 in any other desired sequence or substantially simultaneously. For example, without limitation, the second inflatable chamber 104B could be inflated from the first reference pressure PR1 to the first inflation pressure PI1 first, followed by one of the first inflatable chamber 104A and the third inflatable chamber 104C, followed by the other of the first inflatable chamber 104A and the third inflatable chamber 104C. Likewise, without limitation, the third inflatable chamber 104C could be inflated from the first reference pressure PR1 to the first inflation pressure PI1 first, followed by one of the first inflatable chamber 104A and the second inflatable chamber 104B, followed by the other of the first inflatable chamber 104A and the second inflatable chamber 104B.

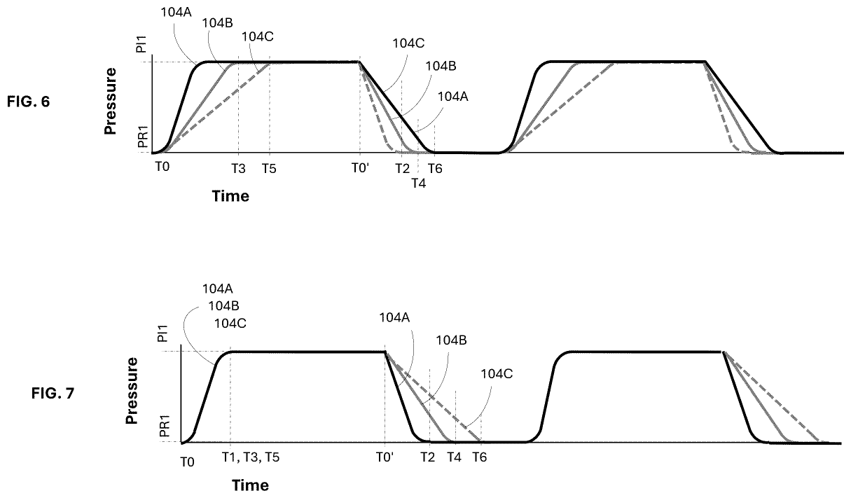

Similarly, the first, second, and third flow control systems 108A, 108B, 108C of the therapeutic device 100 may be configured so that so that the first, second, and third inflatable chambers 104A, 104B, 104C may be depressurized from the first inflation pressure PI1 in any other desired sequence or substantially simultaneously. For example, as shown in in FIG. 6, the third inflatable chamber 104C could be deflated from the first inflation pressure PI1 to the second reference pressure PR2 first, followed by the first inflatable chamber 104A, and then the third inflatable chamber 104C. Likewise, the second inflatable chamber 104B could be deflated from the first inflation pressure PI1 to the second reference pressure PR2 first, followed by the second inflatable chamber 104B, and then the first inflatable chamber 104A. In embodiments, without limitation, the second inflatable chamber 104B could be deflated from the first inflation pressure PI1 to the second reference pressure PR2 first, followed by one of the first inflatable chamber 104A and the third inflatable chamber 104C, followed by the other of the first inflatable chamber 104A and the third inflatable chamber 104C.

In embodiments, for example without limitation as shown in FIG. 7 and suggested above, the first, second, and third flow control systems 108A, 108B, 108C of the therapeutic device 100 may be configured so that so that the first, second, and third inflatable chambers 104A, 104B, 104C may be inflated or pressurized substantially simultaneously and deflated or depressurized in any desired, predetermined sequence.

With continued reference to FIGS. 4-7, the foregoing cycles of pressurization and depressurization may be repeated following a dwell period wherein the first selectively inflatable compartment 102 is in a vented state. The dwell period may be of any duration as short as substantially zero.

As mentioned above, in embodiments, the respective secondary flow regulator 112A, 112B, 112C may be omitted from one or more of, but not all of, the flow control systems 108A, 108B, 108C. In such embodiments, the extent to which the pressurization and depressurization of the first, second, and third inflatable chambers 104A, 104B, 104C may be sequenced may be more limited than in embodiments wherein each and every one of the flow control systems 108A, 108B, 108C includes a secondary flow regulator 112A, 112B, 112C.

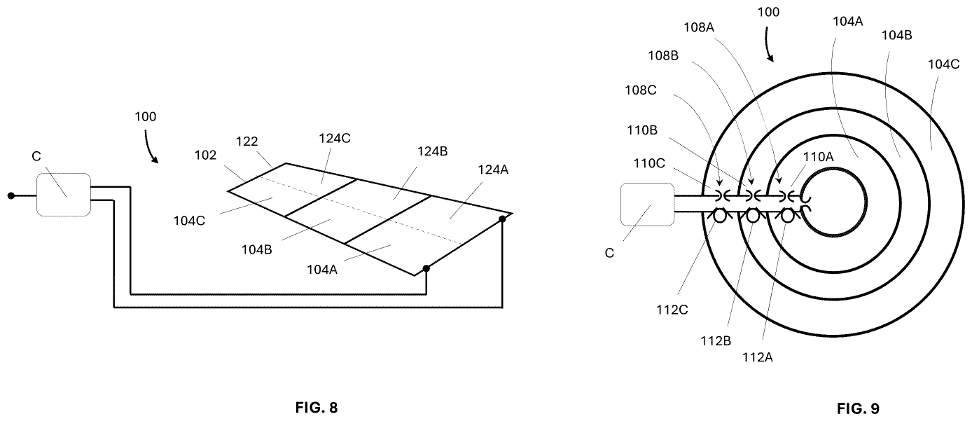

In embodiments, the therapeutic device 100 may include a second selectively inflatable compartment configured in a manner similar to, though not necessarily identical to, the first selectively inflatable compartment 102, for example, as described above. One such non-limiting embodiment is shown in FIG. 8, wherein the therapeutic device 100 includes a second selectively inflatable compartment 122 configured in a manner substantially identical to the first selectively inflatable compartment 102. In this example, the second selectively inflatable compartment 122 includes first, second, and third inflatable chambers 124A, 124B, 124C which are analogous, respectively, to the first, second, and third inflatable chambers 104A, 104B, 104C of the first selectively inflatable compartment 102. Each of the first, second, and third inflatable chambers 124A, 124B, 124C of the second selectively inflatable compartment 122 may include a corresponding flow control system (not independently shown) analogous to the flow control systems 108n of the inflatable chambers 104n of the first selectively inflatable compartment 102. Such a second selectively inflatable compartment may be independently fluidly coupled to the controller C or to another controller and operated independently from the first selectively inflatable compartment 102 in manners, for example, similar to those described above.

In the foregoing embodiments, the first, second and third inflatable chambers 104A, 104B, 104C of the first selectively inflatable compartment 102 are arranged side-by-side, with the second inflatable chamber 104B positioned between the first and third inflatable chambers 104A, 104C. In embodiments, the several inflatable chambers 104n may be arranged in other manners. For example, without limitation, and as shown in FIG. 9, the several inflatable chambers 104n may be arranged concentrically, with the second inflatable chamber 104B partially or substantially completely surrounding the first inflatable chamber 104A, and the third inflatable chamber 104C partially or substantially completely surrounding the second inflatable chamber 104B.

As mentioned above, in embodiments, the first selectively inflatable compartment 102 may include a single inflatable chamber 104 including a corresponding single flow control system 108 as discussed above. In such embodiments, the single flow control system 108 may be configured to enable inflation of the single inflatable chamber 104 at a first rate and to enable deflation of the single inflatable chamber at a second rate different from the first rate further to the principles discussed above.

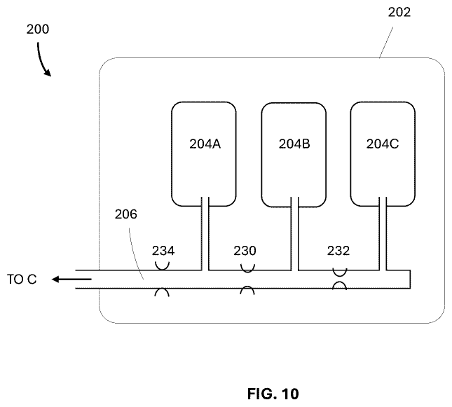

FIG. 10 depicts an alternate embodiment of a therapeutic device 200 having a first selectively inflatable compartment 202 including first, second, and third inflatable chambers 204A, 204B, 204C fluidly connected to a manifold 206, which in turn may be fluidly coupled to the controller C. In this regard, the therapeutic device 200 is similar to the therapeutic device 100 having the first selectively inflatable compartment 102 including the first, second, and third inflatable chambers 104A, 104B, 104C fluidly connected to the manifold 106 and the controller C. The therapeutic device 200 differs from the therapeutic device 100 in that the therapeutic device 200 omits flow control systems analogous to the flow control systems 108A, 108B, 108C uniquely associated with corresponding ones of the first, second, and third inflatable chambers 204A, 204B, 204C. Instead, the therapeutic device 200 includes a first flow restrictor 230 in line with the manifold 206 between the first inflatable chamber 204A and the second inflatable chamber 204B, and a second flow restrictor 232 in line with the manifold 206 between the second inflatable chamber 204B and the third inflatable chamber 204C. The second flow restrictor 232 is configured to impart a greater resistance to flow than the second flow restrictor 230, and the second flow restrictor 232 is configured to impart a greater resistance to flow than any resistance to flow between the control C and the first inflatable chamber 204A (shown schematically as an inlet flow restrictor 234).

In use, when the manifold 206 is charged with pressurized fluid from the controller C, the first, second, and third inflatable chambers begin to pressurize from the first reference pressure PR1 toward the first inflation pressure PI1 substantially simultaneously. The resistances to flow imparted by the first and second flow restrictors 230, 232, however, cause the first inflatable compartment 204A to reach the first inflation pressure PI1 first, followed by the second inflatable compartment 204B, followed by the third inflatable compartment 204B, in a manner similar to that shown in FIG. 4. Similarly, when pressurized fluid is vented from the manifold 206, the first, second, and third inflatable chambers begin to pressurize from the first inflation pressure PI1 toward the second reference pressure PR2 substantially simultaneously. The resistances to flow imparted by the first and second flow restrictors 230, 232, cause the first inflatable compartment 204A to reach the second reference pressure PR2 first, followed by the second inflatable compartment 204B, followed by the third inflatable compartment 204B, in a manner similar to that shown in FIG. 4.

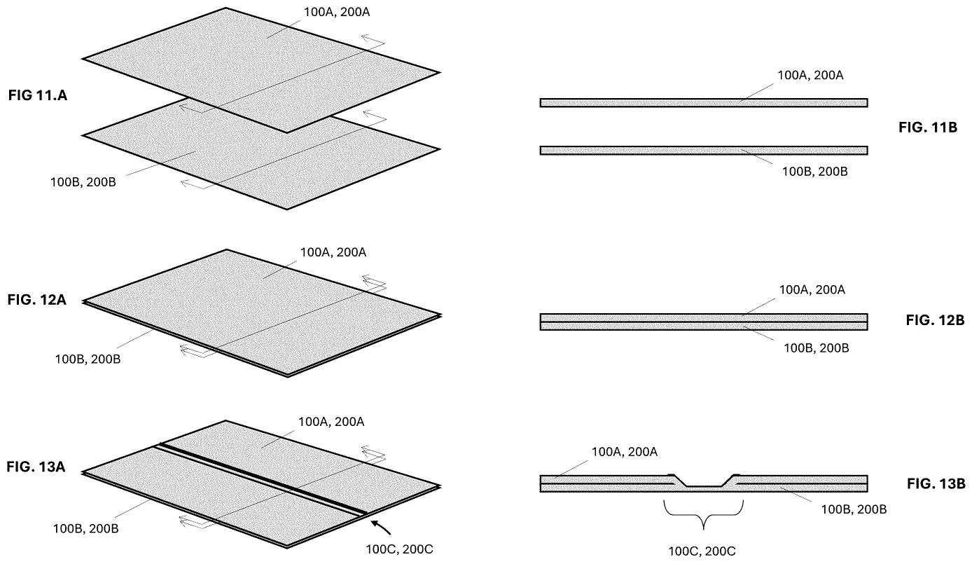

As shown in FIGS. 11A-13B, the therapeutic device 100, 200 may comprise a first flexible sheet 100A, 200A and a second flexible sheet 100B, 200B overlying the first flexible sheet 100A, 200A and joined thereto by one or more welds 100C, 200C. The first flexible sheet 100A, 200A, the second flexible sheet 100B, 200B, and the weld 100C, 200C cooperate to define the first selectively inflatable compartment 102, 202 (and further inflatable compartments in embodiments including the same). The first selectively inflatable compartment 102, 202 may be substantially fluid-tight.

The embodiments shown and described herein are illustrative and not limiting. Those skilled in the art would understand how to modify the illustrative embodiments without departure from the scope of the appended claims.

1. A therapeutic device comprising:
a first selectively inflatable compartment comprising:
a first manifold configured for fluid connection to a controller configured to supply pressurized fluid to, and to relieve the pressurized from, the first manifold;
a first inflatable chamber fluidly coupled to the first manifold, the first inflatable chamber inflatable to a first inflation pressure;
a second inflatable chamber fluidly coupled to the first manifold, the second inflatable chamber inflatable to the first inflation pressure;
a first flow control system fluidly coupled between the first manifold and the first inflatable chamber, the first flow control system configured to regulate flow of fluid into the first inflatable chamber and to regulate flow of fluid out of the first inflatable chamber, wherein the first flow control system comprises a first primary flow regulator; and
a second flow control system fluidly coupled between the first manifold and the second inflatable chamber, the second flow control system configured to regulate flow of fluid into the second inflatable chamber and to regulate flow of fluid out of the second inflatable chamber, wherein the second flow control system comprises a second primary flow regulator;
wherein the first flow control system and the second flow control system are configured to enable pressurization of the first inflatable chamber from a first reference pressure to a first inflation pressure and pressurization of the second inflatable chamber from the first reference pressure to the first inflation pressure substantially simultaneously or in a first predetermined sequence and to enable depressurization of the first inflatable chamber and the second inflatable chamber from the first inflation pressure to a second reference pressure substantially simultaneously or in a second predetermined sequence.

2. The therapeutic device of claim 1, wherein the first flow control system and the second flow control system are configured to enable pressurization of the first inflatable chamber and the second inflatable chamber from the first reference pressure to the first inflation pressure in the first predetermined sequence.

3. The therapeutic device of claim 2, wherein the first flow control system and the second flow control system are configured to enable depressurization of the first inflatable chamber and the second inflatable chamber from the first inflation pressure to the second reference pressure in the second predetermined sequence.

4. The therapeutic device of claim 3, wherein the first predetermined sequence is the same as the second predetermined sequence.

5. The therapeutic device of claim 3, wherein the first predetermined sequence is the different than the second predetermined sequence.

6. The therapeutic device of claim 2, wherein the first flow control system and the second flow control system are configured to enable depressurization of the first inflatable chamber and the second inflatable chamber from the first inflation pressure to the second reference pressure substantially simultaneously.

7. The therapeutic device of claim 1, wherein the first flow control system and the second flow control system are configured to enable pressurization of the first inflatable chamber and the second inflatable chamber from the first reference pressure to the first inflation pressure substantially simultaneously, and wherein the first flow control system and the second flow control system are configured to enable depressurization of the first inflatable chamber and the second inflatable chamber from the first inflation pressure to the second reference pressure substantially simultaneously.

8. The therapeutic device of claim 1, wherein the first primary flow regulator is a flow-restricting orifice.

9. The therapeutic device of claim 1, wherein the first flow control system further comprises a first secondary flow regulator fluidly connected in parallel with the first primary flow regulator.

10. The therapeutic device of claim 9, wherein the first secondary flow regulator is a first check valve.

11. The therapeutic device of claim 9, wherein the first primary flow regulator is a flow-restricting orifice integrated with the first check valve.

12. The therapeutic device of claim 9, wherein the first check valve is configured to enable flow into the first inflatable chamber and to check flow out of the first inflatable chamber.

13. The therapeutic device of claim 9, wherein the second flow control system further comprises a second secondary flow regulator fluidly connected in parallel with the second flow-restricting orifice.

14. The therapeutic device of claim 1, further comprising:
a third inflatable chamber fluidly coupled to the first manifold, the third inflatable chamber inflatable to the first inflation pressure; and
a third flow control system fluidly coupled between the first manifold and the third inflatable chamber, the third flow control system configured to regulate flow of fluid into the third inflatable chamber and to regulate flow of fluid out of the third inflatable chamber, wherein the third flow control system comprises a third primary flow regulator.

15. The therapeutic device of claim 14, wherein the third flow control system further comprises a third secondary flow regulator fluidly connected in parallel with the third primary flow regulator.

16. The therapeutic device of claim 14, wherein the first flow control system, the second flow control system, and the third flow control system are configured to enable pressurization of the third inflatable chamber from the first reference pressure to the first inflation pressure following pressurization of the first inflatable chamber and the second inflatable chamber from the first reference pressure to the first inflation pressure.

17. The therapeutic device of claim 14, wherein the first flow control system, the second flow control system, and the third flow control system are configured to enable depressurization of the third inflatable chamber from the first inflation pressure to the second reference pressure prior to depressurization of the first inflatable chamber and the second inflatable chamber from the first inflation pressure to the second reference pressure.

18. The therapeutic device of claim 14, wherein the first flow control system, the second flow control system, and the third flow control system are configured to enable depressurization of the third inflatable chamber from the first inflation pressure to the second reference pressure following depressurization of the first inflatable chamber and the second inflatable chamber from the first inflation pressure to the second reference pressure.

19. The therapeutic device of claim 1, wherein the therapeutic device is a sequential compression device or a support surface overlay.
